(19) United States
(12) Patent Application Publication
(10) Pub. No.: US 2008/0104258 A1
(43) Pub. Date: May 1, 2008

(54) System and method for dynamic data discovery in service oriented networks with peer-to-peer based communication

(75) Inventors: Brian O'Neill, Pottstown, PA (US); Robert H. Pollack, Philadelphia, PA (US)

Correspondence Address: JONES DAY, 222 East 41st Street, New York, NY, 10017-6702, US

(73) Assignee: Gestalt, LLC, Camden, NJ (US)

(21) Appl. No.: 11/589,131

(22) Filed: Oct. 30, 2006

(51) Int. Cl. G06F 15/16

(52) U.S. Cl. 709/228

(57) ABSTRACT

A method and apparatus for dynamically discovering and communicating data in a communications network are described. A broker in a communications network receives a communication from a first service provider over the communications network, the broker comprising a metabroker and a service broker. The metabroker communicates messages to the service broker within defined time intervals to provide the service broker with any updated information about topics including a first topic. The broker sends information about the first topic to a first service consumer over the communications network within a first time interval from receipt of the communication comprising data about the first topic, and establishes peer-to-peer communication between the first service provider and the first service. The broker receives further communications about topics from multiple service providers over the communications network, and sends further data about to the first topic to the first service consumer.

### BACKGROUND

1. Field of the Invention

The present invention relates to discovery and communication of data across computer networks. In particular, the invention relates to dynamic data discovery and communication in service oriented network with peer-to-peer based communication.

2. Background Information

Services are programs that reside on a computer network such as the Internet and communicate via message exchange. Services are analogous to websites but instead of supplying content, they provide system operations with specific functionality. Typically, services are contacted in the same way as websites, through Universal Resource Locators (URLs) converted to Internet Protocol (IP) addresses. These IP addresses are not dynamic. Therefore, the URLs of services are often discovered via the Universal Description and Discovery Interface (UDDI). UDDI is a service itself that functions as a yellow pages directory for other services. The URLs of services within UDDI are fairly static, as UDDI does not provide a facility for real-time updates to its registry.

Two services systems, which are comprised of a set of deployed services, are publish-and-subscribe systems and event systems. In publish-and-subscribe systems, subscribers express interest in specific topics and receive discrete pieces of information that publishers characterize as belonging to those topics. The connection between subscribers and publishers is generally not point-to-point. Both kinds of entities make their connections to a publish-and-subscribe server that support subscriber requests to subscribe to given topics, and support publishers' requests to publish information on given topics. Publishers and subscribers need not be aware of each other directly.

In event systems, connections between systems are typically point-to-point. Instead of subscribing to a topic, the receiving entity contacts a specific information producer directly and expresses an interest in future information, often without the abstraction of a topic. In event systems, the sending and receiving entities are usually called producers and consumers, rather than publishers and subscribers.

Publish-and-subscribe systems and event systems provide roughly equivalent results, in that a single request for information produces multiple responses sent at arbitrary times. As a result, both publish-and-subscribe systems and event systems are characterized as asynchronous notification systems.

Traditional publish-and-subscribe mechanisms are implemented as closed systems, in the sense that the topics available to subscribers are predefined. Traditional event systems are also closed systems, in the sense that consumers must decide which producers will be accessed based on some advance knowledge of which producers may produce information of interest. Both of these therefore limit the ability to discover information sources that might be of interest. This is particularly the case for those sources come into existence dynamically. If new topics become available in a publish-and-subscribe system or if new information producers come on-line in an event system, consumers have no way of knowing that this has happened.

In both kinds of asynchronous notification systems, receiving information relevant to specific needs is a difficult process. Publish-and-subscribe systems require the consumer to know the subscription topics in advance. Moreover, because topics are chosen in advance, they tend to be broad, coarse-grained categories. To obtain information in specific, fine-grained areas requires the consumer to accept large amounts of irrelevant information.

Event systems impose a different problem. Because a consumer has no way of knowing whether a given producer has relevant information, the consumer must subscribe to many different producers. Here the expense is in maintaining large numbers of subscriptions.

Moreover, neither kind of asynchronous notification system provides a means by which consumers can easily discover new sources of relevant information. There is no way for consumers to know when new topics are available in a publish-and-subscribe system. In an event system, while consumers can query the UDDI repository to find new producers, they have no way of knowing if those producers ever produce information of interest.

### SUMMARY

According to one aspect, a computer-based method for dynamically discovering and communicating data in a communications network comprises: receiving, at a broker in a communications network, a communication from a first service provider over the communications network, the communication comprising data about a first topic, the broker comprising a metabroker and a service broker; communicating messages from the metabroker to the service broker within defined time intervals to provide the service broker with any updated information about topics including the first topic; sending information about the first topic to a first service consumer over the communications network within a first time interval from receipt of the communication comprising data about the first topic; establishing peer-to-peer communication between the first service provider and the first service consumer over the communications network so that the first service provider and the first service consumer can communicate regarding the first topic; receiving further communications about topics from multiple service providers over the communications network, at least one of the further communications including further data about the first topic; and sending information about the further data to the first service consumer within a second time interval from receipt of the further data.

According to another aspect, an apparatus for dynamically discovering and communicating data in a communications network comprises a processing system and memory coupled to the processing system, wherein the processing system is configured to execute the steps of the above-noted method.

According to another aspect, a computer readable medium has embodied therein executable program code for dynamically discovering and communicating data in a communications network, wherein the executable program code is adapted to a cause a processing system to execute the above-noted method.

According to another aspect, a communications system for dynamically discovering and communicating data in a communications network comprises a first broker and a second broker in a communications network, wherein each of the first and second brokers comprises a processing system and a memory coupled to the processing system, wherein the processing system of each of the first and second brokers is configured to execute steps of the above-noted method.

### BRIEF DESCRIPTION OF THE FIGURES

FIG. 1A illustrates a functional block diagram of an exemplary service oriented network in accordance with the invention.

FIG. 1B illustrates a functional block diagram of an exemplary metabroker in accordance with the invention.

FIG. 2 illustrates a flow diagram of an exemplary method for dynamically discovering and communicating data in a communications network in accordance with the invention.

FIG. 3 illustrates a flow diagram of an exemplary method of creating and monitoring a topic using a metabroker in a service oriented network in accordance with the invention.

FIG. 4 illustrates a flow diagram of an exemplary method of delivering an event using a metabroker in a service oriented network in accordance with the invention.

FIG. 5 illustrates a flow diagram of an exemplary method of subscribing to a topic using a metabroker in a service oriented network in accordance with the invention.

### DETAILED DESCRIPTION

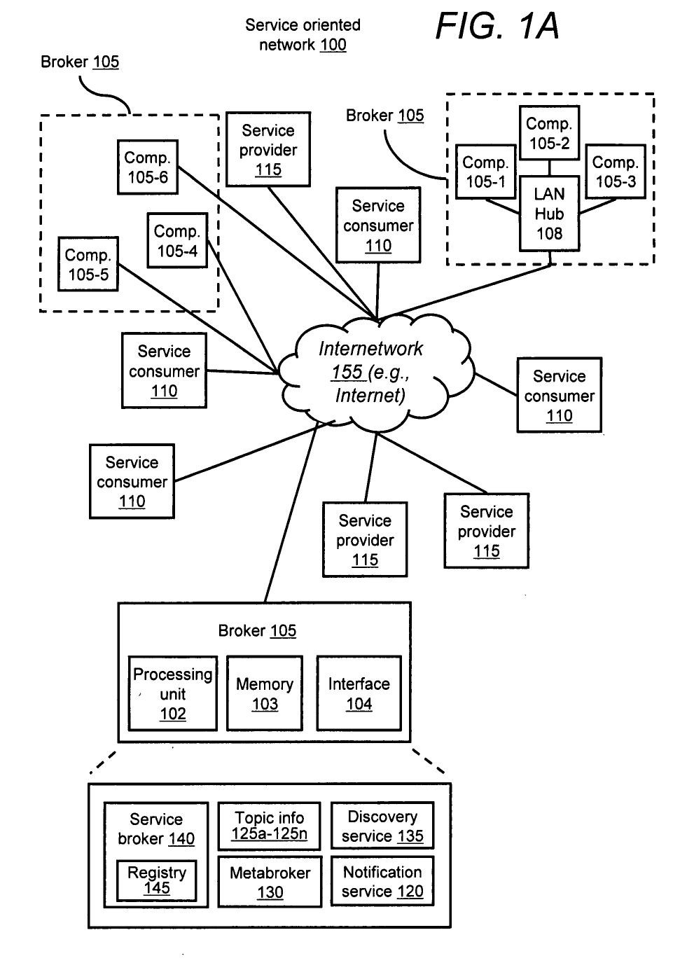

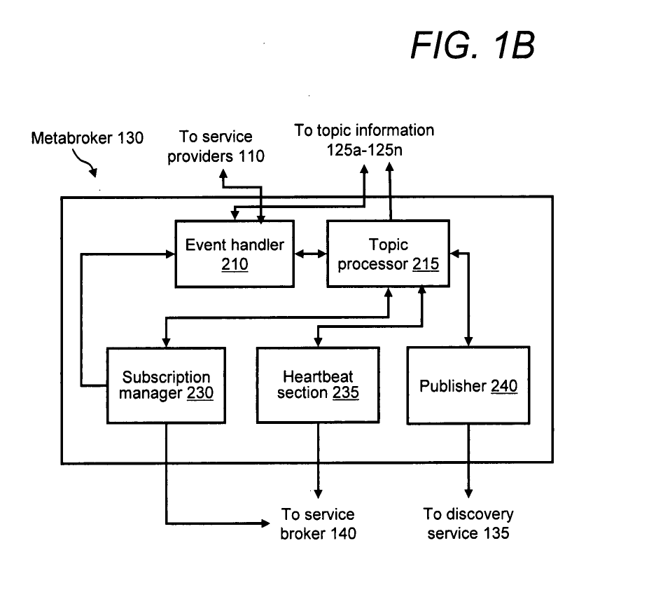

FIG. 1A illustrates a functional block diagram of an exemplary service oriented network 100 in accordance with the invention. Service oriented network 100 includes a plurality of service consumers 110, a plurality of service providers 115, and a plurality of brokers 105 interconnected by an internetwork 155, such as the Internet. Service consumers 110, service providers 115, and brokers 105 each comprise computer systems that can communicate with the internetwork 155 via any suitable wired or wireless connections or combinations thereof. For example, service consumers 110, service providers 115, brokers 105 can each communicate with the internetwork 155 via any suitable respective local area network (LAN), which may include, for example, a conventional high performance, asynchronous message bus, such as Ethernet, Java™ Message Service (JMS) bus, or other suitable bus (JMS is Sun Microsystems' (Santa Clara, Calif.) standard API for message queuing systems).

Service oriented network is “service oriented” in the sense that it includes entities that utilize a service oriented architecture (SOA), that is, an architecture comprising multiple services that communicate with each other, wherein a client of a service is independent of the service (typically referred to “loose coupling”) and wherein software interfaces for the services are independent of software platform. The service oriented network may employ a conventional SOA, for example, an architecture wherein services are integrated using XML (Extensible Markup Language) to tag data, SOAP (Simple Object Access Protocol) to transfer data, WSDL (Web Services Description Language (WSDL) to describe available services, and UDDI (Universal Description and Discovery Interface) to list available services. Such integration tools are well known to those of ordinary skill in the art and require no further description. It should be understood, however, that service oriented network 100 is not limited to these or other integration tools, and that any suitable integration tools, whether presently available or later developed, may be used in conjunction with the techniques described herein.

Service providers 115 are entities in the service oriented network 100 that provide services and information, such as, for example, client applications that provide data in the form of services or applications. For example, a service provider 115 could comprise a computer system in communication with a networked traffic camera to provide a video feed via the internetwork 155 such that video information can be made available via the World Wide Web (WWW). Another example of a service provider includes an unmanned, aerial vehicle equipped with a computer system and video surveillance equipment and suitable wireless communication capability for communicating over a wireless packet-switched network, for example, and whose information can be made available via the WWW. A further example of a service provider includes a ground patrol of military troops equipped with a mobile computer system and video surveillance equipment and wireless communication capability, whose information can be made available via the WWW. Establishing suitable wired or wireless communications to a network such as the Internet and providing suitable security to transmitted data, e.g., using encryption, is well known to those of ordinary skill in the art. It should be understood that, as used herein, a service provider 115 is not restricted to a single computer node in the network 100. A service provider 115 may comprise distributed entities (e.g., multiple computer systems that are physically separated and communicate with each other), and as such, a service provider 115 may have multiple logical and physical addresses.

Service consumers 110 are entities in the service oriented network 100 that desire to receive services and information, and include, for example, computer systems comprising client applications that request data by invoking services or applications. For example, service consumer 110 can comprise a computer system with a conventional Internet browser application enabled to invoke services or applications through Hypertext Markup Language (HTML) or Extensible Markup Language (XML) documents, e.g., web pages. Services can be conventional, self-contained modular applications that can be described, published, located, and invoked over a network, generally the Internet, such that associated information can be made available via the WWW. It will be appreciated that service consumers can also be service providers, and vice versa. It should be understood that, as used herein, a service consumer 110 is not restricted to a single computer node in the network 100. Service consumers 110 may comprise distributed entities (e.g., multiple computer systems that are physically separated and communicate with each other), and as such, a service consumer 110 may have multiple logical and physical addresses.

Brokers 105 are entities that carry out discovery and cataloging of information from service providers 115 and that facilitate communication of information between service providers 115 and service consumers 110. As illustrated in FIG. 1A, a broker 105 can comprise, for example, a single computer, which may comprise one or more processing units 102, a memory 103, and a communications interface 104. The memory 102 and the communications interface 104 are coupled to the processing unit 102, which is to say that these components are able to communicate with the processing unit 102, not that they are necessarily in immediate physical or mechanical contact with the processing unit 102, or each other.

A broker 105 can also comprise multiple computers, e.g., such as computers 105-1, 105-2, and 105-3 in communication with a local area network (LAN) hub 108 that cooperate to carry out functional tasks of a broker (e.g., including, but not limited to, discovering information, cataloging information, and facilitating communication of information between service providers and service consumers). A broker 105 can also comprise multiple computers, e.g., such as computers 105-4, 105-5 and 105-6 that are independently connected to the internetwork 155 and that cooperate to carry out functional tasks of a broker (e.g., including, but not limited to, discovering information, cataloging information, and facilitating communication of information between service providers and service consumers). It will be appreciated that, for brokers that comprise multiple computers, one or more functional attributes (to be described further below) may be carried out by one or more given computers, and one or more other functional attributes may be carried out by one or more other computers. That is, various functional attributes of a broker may be distributed across multiple computers, which can communicate with each other and other devices in any suitable fashion.

In view of the above, it will be appreciated that a broker can comprise a processing system, memory and a communications system, all of which may be located at a single computer, or which may be distributed across multiple computers so as to comprise multiple processing units, multiple memories, and multiple computer interfaces. The processing system can comprise any suitable computer processing unit or combination of processing units, and/or can include a suitable combination of hardware, firmware and/or specialized circuitry to carry to the methods disclosed herein. Memory 103 can comprise any suitable memory such as one or more magnetic disks, optical disks, solid state memory, other type of memory, or any suitable combination thereof. Communications interface 104 can comprise any suitable interface (e.g., Ethernet or other) for establishing communication with other devices communicating over the network 155. It will be appreciated that the computer systems of brokers 105 may include a variety of other components such as display units, input devices such as keyboards, etc. Since a broker 105 may comprise distributed entities, it will be appreciated that a broker 105 may have multiple logical and physical addresses.

From a functional perspective, a broker 105 may comprise a service broker 140 (which may include a registry 145), a metabroker 130, a notification service 120, and a discovery service 135, as well as topic information 125a-125n for n topics. Service broker 140, registry 145, a metabroker 130, notification service 120, and discovery service 135 comprise suitable algorithms (e.g., embodied in software and/or firmware) that are executed a suitable computer system or computer systems to carry out their respective functions as will be described further below. It will be appreciated that a broker 105 can be functionally configured in any suitable way. For example, service broker 140 (which may include a registry 145), metabroker 130, notification service 120, discovery service 135, and topic information 125a-125n for n topics could all be configured on a single computer. Alternatively, metabroker 130 could be configured on one computer, service broker could be configured on another computer, metabroker 130, notification service 120, and discovery service could be configured on yet another computer, and topic information 125a-125n could be configured on yet another computer, all of which can communicate and cooperate with each other to carry out the functions of the broker, as another example. Many other examples of distributing these functional aspects across multiple computers will be apparent to those skilled in the art.

Notification service 120 comprises an algorithm (e.g., implemented via software and/or firmware) that enables maintaining updated information on the location, e.g., Uniform Resource Locators (URLs), file locations, IP addresses, etc., of data feeds or other information sources for various topics (e.g., it maintains and updates addresses for pieces of topic information 125a-125n). Notification service 120 may also carry out functions of creating new topics, subscribing to topics (both new and existing), unsubscribing to topics, and removing topics. Notification service 120 can comprise, for example, conventional Publish/Subscribe (PUBSUB)-based software that manages such information for a plurality of topics (i.e., topic information 125a-125n), or any other suitable software and/or firmware for maintaining location information pertinent to topic information 125a-125n.

Topic information 125a-125n includes metadata about various topics, including, but not limited to, content and location of application data and/or services published by service providers 115 relating to a topic. Topic information 125a-125n may include, for example, names/descriptions of topics and sub-topics of interest (e.g., organized in a hierarchical fashion), names of associated services that provide information about such topics, and associated storage locations/addresses (e.g., database record address, other memory address, URLs, Internet Protocol (IP) addresses, etc.) pointing to where such information can be obtained. For example, various service providers 115 may publish (for access via a network) information about current pieces of information (e.g., data feeds, video, new documents, etc.) regarding military intelligence relating to various topics, such as WMDs, and topic information 125a can include, for example, geographical GPS coordinates (longitude, latitude) of sites of interest, types of weaponry believed to be present, age of information about such sites, and one or more URLs or Internet Protocol (IP) addresses indicating where the information may be obtained. The topic information 125a is not limited to the examples mentioned above and can include any suitable descriptors to describe the pieces of information.

Service broker 140 comprises an algorithm (e.g., implemented via software and/or firmware) that enables receiving requests for information/services from various service consumers 110 and intelligently brokering the communication of information/services between service consumers 110 and service providers 115 (e.g., it can comprise an intelligent routing engine). In particular, service broker 140 can establish peer-to-peer communication between service providers 115 and the service consumers 110 over the network 100 so that service providers 115 and service consumers 110 can communicate regarding one or more topics. Methods by which an intermediary can establish peer-to-peer communication between a service provider and a service consumer are well known in the art, and service broker 140 can use any such conventional method or other suitable approach for establishing peer-to-peer communication between service providers 115 and service consumers 110.

Service broker 140 may further include a registry 145 for storing a record of participating services within the network 100, e.g., services or application data of service providers 115. Service broker 140 can discover locations of service providers 115 by interacting with discovery service 135. Service broker 140 can be associated with one or more service access points (SAP), which provide addresses, e.g., URLs, which service consumers 110 can use to request access from broker 105, and which are published in discovery service 135.

Discovery service 135 comprises an algorithm (e.g., implemented via software and/or firmware) that provides information on the locations of available services and information (e.g., addresses for information sources and services relating to topics 125a-125n) within the network 100. Discovery service 135 can be, for example, a UDDI registry that lists the locations, e.g., URLs, of available services related to various topics, much like topic-organized phone numbers in a telephone directory. Notification service 120 routinely updates the listings of discovery service 135 based on publish and subscribe events relating to topics 125a-125n within service oriented network 100. For instance, notification service 120 may update its entries to specify the location of a new military intelligence video data feed relating to a given topic.

Metabroker 130 comprises an algorithm (e.g., implemented via software and/or firmware) that dynamically monitors and extracts data flowing to and from nodes in network 100 about topics 125a-125n. Metabroker 130 additionally communicates with entities such as, e.g., service broker 140 regarding changes to topics, provides subscribe and unsubscribe services to entities such as, e.g., service consumers 110, and provides updates to registry 145 and to directory service 135. In addition to service brokers 140 and service consumers 110, metabroker may also communicate with (e.g., be accessed by) other entities such as, e.g., search engines (e.g., so that a user of a search engine may be able to obtain updated metadata about a topic).

As illustrated in FIG. 1B, metabroker 130 may include various functional attributes, such as, for example, an event handler 210, a topic processor 215, a context 220, a subscription manager 230, a heartbeat section 235, and a publisher 240. Event handler 210 comprises an algorithm (e.g., implemented via software and/or firmware) that acts on behalf of a service consumer 110 who has subscribed to a particular topic. Event handler 210 monitors topic information 125i about a given topic and notifies the subscribing service consumer 110 when new or updated information is available, or when a given type of event has occurred, or when a suitable trigger has occurred in whatever fashion as requested/specified by the subscribing service consumer 110. The notification includes both location (e.g., URL address) of the pertinent information and a brief description of the pertinent information.

Topic processor 215 comprises an algorithm (e.g., implemented via software and/or firmware) that monitors information flowing to and from any suitable computer nodes in network 100 that store topic information 125a-125n, and updates topic information 125a-125n accordingly. Topic processor 215 extracts descriptors and address locations relating to data for topics and stores some or all of such metadata in topic information 125a-125n. The format for the data stored in topic information 125a-125n can be XML documents stored in a conventional database or file in memory. Topic processor 215 can utilize, if desired, rules-based processing to determine how/whether to update certain metadata. The use of rules-based processing is well known, and a suitable implementation of rules-based processing in this regard is within the purview of one of ordinary skill in the art in view of nature of the topic and/or application at hand.

Subscription manager 230 comprises an algorithm (e.g., implemented via software and/or firmware) that allows service consumers 110 to subscribe and unsubscribe to a topic via service broker 140, and stores subscription information in suitable form, e.g., in XML or SQL (Structured Query Language) which are well known to those of ordinary skill in the art. In an exemplary embodiment, subscription manager 230 does not create and delete topics (this aspect is handled by notification service 120). Subscription manager 230 is further responsible for updating registry 145 of service broker 140 with new information or changed information regarding services and/or application data of service providers 115 within the network 100.

Heartbeat section 235 comprises an algorithm (e.g., implemented via software and/or firmware) that communicates messages (e.g., short messages typically in XML format, etc.) within defined time intervals to service brokers 140 to provide service brokers 140 with any updated information about topic information 125a-125n for which service broker 140 should be made aware. Heartbeat section 235 can obtain this updated information by communicating with topic processor 215. In this way, service broker 140 may contain near real-time status information about topic information 125a-125n. These messages can be sent, for example, at defined intervals of 5, 10, 20, 30, or more seconds. The messages can be sent at regular intervals (e.g., spaced by the same amount of time) or at varying intervals. The time intervals are not restricted to the time intervals noted above, however, and sending requests within other time intervals, such as, 1, 5, 10, 30, and 60 minutes can be advantageous. The messages are sent by heartbeat section 235 to service broker 140 at defined time intervals regardless of whether any updates to topic information actually exist at the time of communicating the messages. If updated topic information exists, heartbeat section 235 communicates that fact to service broker 140. If updated topic information does not exist at the time, heartbeat section 235 nevertheless communicates a message to service broker 140, e.g., merely informing service broker 140 of heartbeat section's presence. In this instance, heartbeat section 235 could also communicate to service broker 140 a message that no updates to topic information 125a-125n currently exist. Thus, in this fashion, service broker 140 can be provided with updated topic information 125a-125n in near real time.

Publisher 240 comprises an algorithm (e.g., implemented via software and/or firmware) that monitors new and updated data of topic information 125a-125n and that updates discovery service 135 with location information associated with the new/updated data. As topic information 125a-125n is updated, publisher 240 determines how/whether to update discovery service 135. Publisher 240 can utilize, if desired, rules-based processing to determine how/whether to update entries in discovery service 135. The use of rules-based processing is well known, and a suitable implementation of rules-based processing in this regard is within the purview of one of ordinary skill in the art.

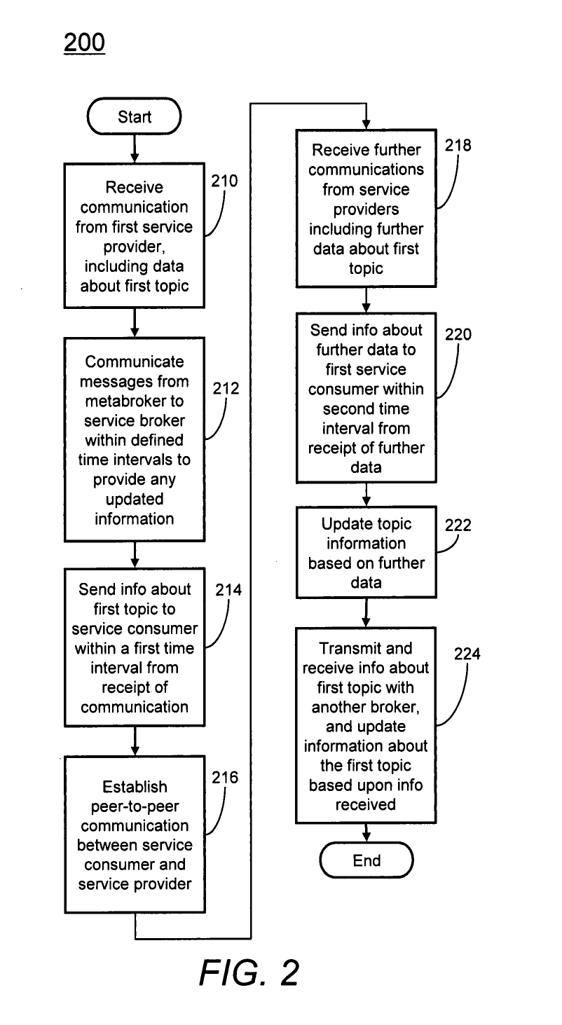

FIG. 2 illustrates a flow diagram of an exemplary computer-based method 200 for dynamically discovering and communicating data in a communications network in accordance with the invention. It should be appreciated that the steps of the exemplary method 200 need not occur in the order shown and described.

At step 210, the broker 105 receives a communication from a service provider 115 over the communications network, including data about a topic (e.g., subject matter associated with a topic or sub-topic, regardless of how the subject matter is characterized within a topical hierarchy). The topic may be referred to herein as a first topic, and the service provider 115 may be referred to herein as a first service provider 115. The use of the term “first” in this regard should be understood to be a convenient label, and is not intended to refer to order or timing unless otherwise indicated. The broker 105 can receive many such communications about various topics from multiple service providers.

At step 212, metabroker 130 of broker 105 communicates messages to service broker 140 of broker 105 within defined time intervals to provide any updated information metabroker 130 may have identified regarding the first topic. As noted previously, the metabroker 130 can carry out this step using heartbeat section 235, comprises an algorithm (e.g., implemented via software and/or firmware) that communicates messages (e.g., short messages typically in XML format, etc.) within defined time intervals to service brokers 140 to provide service brokers 140 with any updated information about topic information 125a-125n for which service broker 140 should be made aware. Heartbeat section 235 can obtain this updated information by communicating with topic processor 215. In this way, service broker 140 may contain near real-time status information about topic information 125a-125n. These messages can be sent, for example, at defined intervals of 5, 10, 20, 30, or more seconds. The messages can be sent at regular intervals (e.g., spaced by the same amount of time) or at varying intervals. The time intervals are not restricted to the time intervals noted above, however, and sending requests within other time intervals, such as, 1, 5, 10, 30, and 60 minutes can be advantageous. The messages are sent by heartbeat section 235 to service broker 140 at defined time intervals regardless of whether any updates to topic information actually exist at the time of communicating the messages. If updated topic information exists, heartbeat section 235 communicates that fact to service broker 140. If updated topic information does not exist at the time, heartbeat section 235 nevertheless communicates a message to service broker 140, e.g., merely informing service broker 140 of heartbeat section's presence. In this instance, heartbeat section 235 could also communicate to service broker 140 a message that no updates to topic information 125a-125n currently exist. Thus, in this fashion, service broker 140 can be provided with updated topic information 125a-125n in near real time.

At step 214, the broker 105 sends information about the first topic to a service consumer 110 (first service consumer) within a first time interval from receipt of the communication comprising data about the first topic, e.g., based on a previous request from service consumer 110. The information sent can include, for example, a URL for an updated web page that displays updated information about the first topic as well as various descriptors for various data feeds about various topics, information about when those feeds were last updated, and indicators indicating whether near real-time data is presently available for given data feeds, etc. The previous request by the first service consumer 110 can be any suitable type of request, such as, for example, clicking on a link of a web page provided by the broker 105 that has been encrypted using any suitable approach, the link being viewable by the first service consumer 110 within a hierarchy of topics and sub-topics. By recording the service consumer's 110 click on a such a link, the broker 105 can register the service consumer's 110 interest in the first topic such that the broker 105 will know to send information about the first topic to the service consumer 110 in the event of updated information. Alternatively, the request by the service consumer 110 may be in any of a variety of suitable message formats (e.g., XML) with content tailored to the service consumer's request, and can include, for example, a link to new or updated information pertinent to the service consumer's request. If the subject matter of the service consumer's request is broad and implicates a substantial number of topics and/or sub-topics, the broker 105 may respond by sending an appropriate reply to the first service consumer 110 with metadata about related topics/sub-topics to allow the service consumer to narrow the request. As another example, the service consumer's request could comprise a subscription to a given topic/sub-topic placed by first service consumer 110, the subscription being handled by event handler 210 as described elsewhere herein.

The first time interval can be predefined to be a relatively short time interval, e.g., such as 1, 5, 10, 30 or 60 seconds, for example, and can be generated in response to a message from heartbeat section 235 to service broker 140, such that if updated information now exists about a topic that is of interest to a service consumer (e.g., first topic, which is of interest to first service consumer), the broker 105 sends a communication about the information of the topic to the interested service consumer 110. Any such choice would permit the service consumer to receive the above-noted information in near real time. Longer predefined time intervals could also be used, e.g., 1, 5, 10, 30 60 minutes. Alternatively, the broker 105 (e.g., via the heart beat section 235) could select the first time interval depending upon available processing system resources within the broker 105 and based upon the relative importance of the information about the first topic using any suitable rules-based processing based upon any suitable indicators of importance (e.g., tags for different levels of importance) stored in topic information 125a-125n.

At step 216, the broker 105 may establish peer-to-peer communication (e.g., via service broker 140) between the first service provider 115 and the first service consumer 110 over the communications network so that the service provider 115 and the service consumer 110 can communicate regarding the topic, if instructed, for example, by the service consumer 110. The first service consumer 110 can provide such an instruction to establish peer-to-peer communication, for example, by clicking a suitable link on a web page of the broker 105 that is being accessed by the first service consumer 110. As noted elsewhere herein, methods by which an intermediary can establish peer-to-peer communication between a service provider and a service consumer are well known in the art, and broker 105 can use any conventional method or other suitable approach for establishing peer-to-peer communication between the first service provider 115 and the first service consumer 110.

The broker 105 may identify the first service provider 115 (also referred to a first service provider 115 herein) as a source of information about the first topic based upon the first service consumer's 110 request, and based upon accessing topic information 125a-125n, discovery service 135 and registry 145 to identify and check the status of information about the topic and associated service providers 115.

At step 218, broker 105 receives further communications about topics from multiple service providers over the communications network, wherein at least one of the communications includes further data about the first topic. In response to these communications, the broker, through its various functional attributes (described elsewhere herein) can update its entries regarding topic information 125a-125n and establish multiple peer-to-peer communications between various service consumers 110 and various service providers 115, e.g., as initiated by the service consumers 110.

At step 220 the broker 105 sends a communication about the further data to the first service consumer 110 within a second time interval from receipt of the further data about the topic of interest (first topic). Similar to the first time interval, the second time interval can be predefined to be a relatively short time interval, e.g., such as 1, 5, 10, 30 or 60 seconds, for example. As suggested previously, the communication about the further data can be generated in response to a message from heartbeat section 235 to service broker 140, such that if updated information now exists about a topic that is of interest to a service consumer (e.g., first topic, which is of interest to first service consumer), the broker 105 sends a communication about the information of the topic to the interested service consumer 110. Any such choice would permit the service consumer 110 to receive the above-noted information in near real time. Longer predefined time intervals could also be used, e.g., 1, 5, 10, 30 60 minutes. Alternatively, the broker 105 (e.g., via the heart beat section 235) could select the first time interval depending upon available processing system resources within the broker 105 and based upon the relative importance of the information about the first topic using any suitable rules-based processing based upon any suitable indicators of importance (e.g., tags for different levels of importance) stored in topic information 125a-125n.

At step 222, the broker 105 (via its various functional attributes described elsewhere herein) can update topic information 125a-125n based upon the further data received regarding the first topic, e.g., via topic processor 215 such as described elsewhere herein.

At step 224, the broker 105 can communicate with another broker 105 in the communications network, transmit and receive information relating to the first topic, and update information about the first topic based upon the information received.

The method 200 can repeat as many times as desired, and in practice, will typically run in an ongoing manner. The method can end whenever desired.

In the exemplary method 200 described above, it should be understood that many entities may carry out communications as described in the example, and that a given broker 105 may communicate with multiple service providers 110 and multiple service consumers 115. Also, a given broker 105 may identify multiple service providers 115 who can supply information/services to in response to a request for information/services from a given service consumer 110. All of these possibilities, as well as others, are intended to be embraced by the appended claims.

As with other exemplary methods described herein, above-described method 200 can be implemented with any suitable processing system of one or more computers that can communicate with each other and that can be distributed in any suitable fashion. Processing instructions for causing such a processing system to execute the methods described herein can be embodied in any suitable computer readable medium. For example, the computer-readable medium may include a floppy disk, a flexible disk, hard disk, magnetic tape, or any other magnetic medium, a CD-ROM, any other optical medium, RAM, ROM, EPROM, FLASH memory, any other suitable memory chip or cartridge, or any other medium from which a computer can read. Processing instructions may also be provided to the processing system via a modulated wave or signal carrying the instructions, e.g., a downloadable set of instructions. In alternative embodiments, hard-wired circuitry may be used in place of or in combination with software and/or firmware instructions to implement the exemplary methods described herein. Thus, embodiments of the invention are not limited to any specific combination of hardware circuitry, software, and/or firmware, and a processing system as referred to herein may include any suitable combination of hardware and/or software whether located in a single location or distributed over multiple locations.

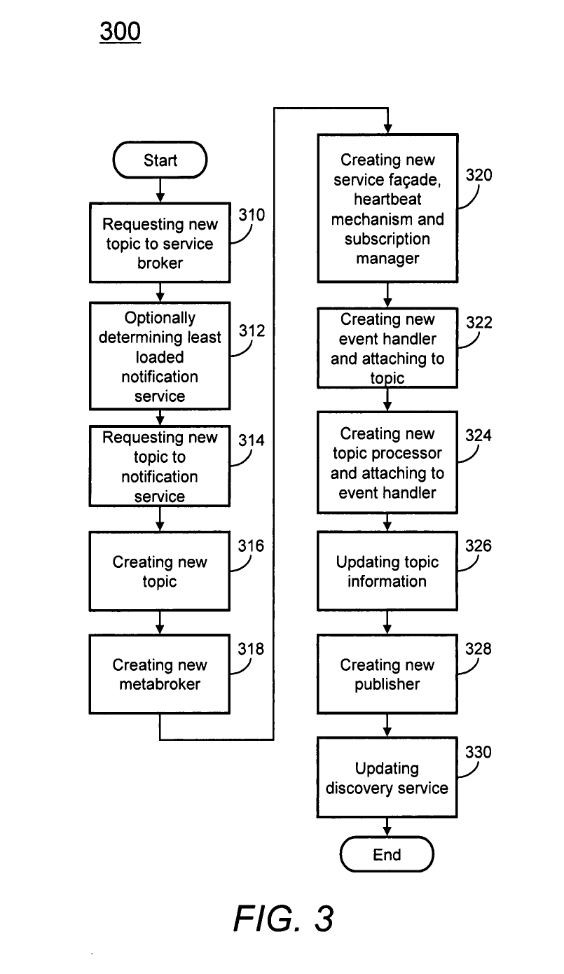

In the examples described above, a metabroker 130 associated with a given broker 105 dynamically monitors and extracts data flowing through broker 105 regarding topics, among other things. In another embodiment, broker 105 can be functionally configured so that each topic has its own metabroker 130i that is responsible for monitoring, extracting and updating information associated with topic information 125i. In this regard, FIG. 3 illustrates a flow diagram of an exemplary method 300 of creating a new topic and metabroker in service oriented network 100 in accordance with the invention.

At step 310, service provider 115 communicates with service broker 140 and sends a request to create a new topic on service oriented network 100. The default format of this request can be an XML document encoded with a SOAP specification that service broker 140 understands. For example, service provider 115 can be an unmanned, aerial vehicle with any conventional computing system running a client application enabled to share intelligence video data over service oriented network 100. The client application sends a request for a new topic to service broker 140 in the form of an XML document, where the topic name can be specified as part of the request, e.g., “intelligence feed.”

At step 312, upon receipt of a request for a new topic from service provider 115, service broker 140 can determine, if desired, the least loaded notification service 120 currently available on service oriented network 100. Determination of least loaded notification service is a conventional calculation well known in the art that involves understanding the current workloads of all available notification services 120 and calculating the notification service with the lowest workload.

At step 314, service broker 140 receives the request for a new topic from service provider 115, communicates with notification service 120 (e.g., the least loaded notification service as determined in step 312), and sends a request to create a new topic on service oriented network 100. The default format of this request is an XML document encoded with a SOAP specification that notification service 120 understands. For example, service broker 140 can be a message router or proxy that sends a request for a new topic to notification service 120, such as a publish and subscribe system, in the form of an XML document, where the topic name is specified as part of the request, e.g., “intelligence feed.”

At step 316, notification service 120 receives the request for a new topic from service broker 140 and creates a new topic 125 on service oriented network 100. In the continuing example, notification service 120 creates a new entry, 125i, in topic information 125a-125n and stored both the topic name, i.e. “intelligence feed”, and suitable metadata such as described previously herein about topic in topic information 125i (the metadata can also include the date of creation of the topic).

At step 318, notification service 120 creates a new metabroker 130 on service oriented network 100 by creating a new metabroker object or process from a template metabroker object or process. Notification service 120 further provides the name of the new topic, i.e. “intelligence feed”, which is associated with new topic information 125i to which metabroker 130 should attach.

At step 320, metabroker 130 creates a new heartbeat section 235 and subscription manager 230 on service oriented network 100 from appropriate templates. Newly created heartbeat section 235 communicates with service broker 140, and announces both the availability of the newly created topic, and its name, e.g., “intelligence feed.” Service broker 140 may update its registry 145 with this new information. Subscription manager 230 further communicates with service broker 140 and announces the availability for service consumers 110 to subscribe and unsubscribe for notifications about intelligence feed topic 125.

At step 322, metabroker 130 creates a new event handler 210 on service oriented network 100 from a template event handler object or process as part of the new metabroker 130, such that event handler 210 can monitor the newly created topic. In the continuing example, event handler 210 now monitors data flowing to and from the newly created topic information 125i for the intelligence fee.

At step 324, metabroker 130 creates a new topic processor 215 on service oriented network 100 from a template topic processor object or process as part of new metabroker 130. Metabroker 130 then instructs event handler 210 to transfer all data flowing to and from topic information 125i to topic processor 215. In the continuing example, topic processor 215 monitors data regarding intelligence feeds.

At step 326, topic processor 215 extracts basic metadata information about the new topic and stores this metadata in topic information 125i, thus updating topic information 125i with default information about the new topic.

At step 328, metabroker 230 creates a new publisher 230 on service oriented network 100 from a template publisher object or process as part of new metabroker 130.

At step 330, metabroker 130 instructs publisher 230 to update discovery service 135 with default information about the newly created topic. In the continuing example, publisher 230 communicates new intelligence feed topic information to discovery service 135, and a new intelligence feed entry is created in UDDI format of discovery service 135. Method 300 ends.

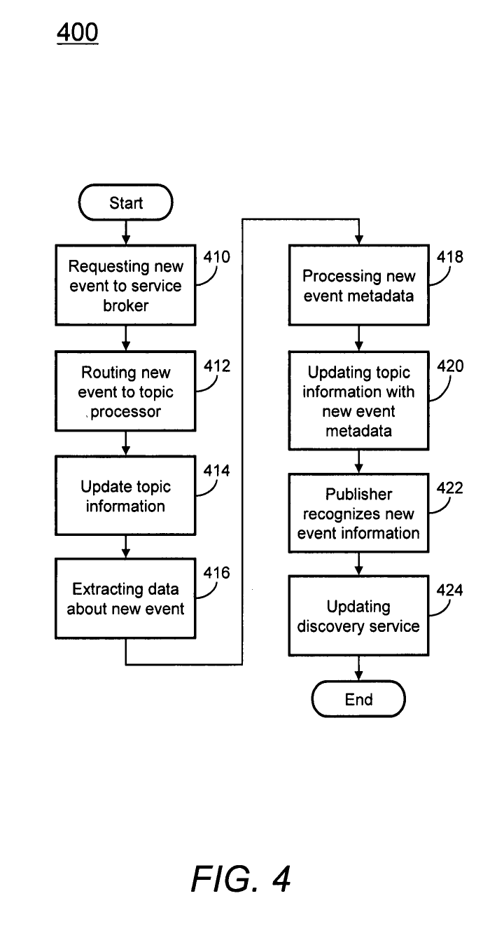

FIG. 4 illustrates a flow diagram of an exemplary method 400 of delivering an event using a metabroker in a service oriented network in accordance with the invention. At step 410, service provider 115 communicates with service broker 140 and sends a request to create a new event, or information, about a topic on service oriented network 100. The default format of this request is an XML document encoded with a SOAP specification that service broker 140 understands. For example, service provider 115 can be an unmanned, aerial vehicle with any conventional computing system running a client application enabled to share intelligence video data over service oriented network 100. The client application sends a request to create a new event to service broker 140 in the form of an XML document, such as, for example, an intelligence video data feed of a suspected weapon of mass destruction (WMD) in the continuing example.

At step 412, service broker 140 routes the request for a new event to topic processor 215 and includes information about the topic of interest, such as topic name or topic keywords, in the request.

At step 414, topic processor 215 updates the appropriate topic information, e.g., for “intelligence data feeds” in the continuing example.

At step 416, topic processor 215 monitors data flowing to and from broker 105 about the new event, and further updates the appropriate topic information.

At step 418, topic processor 215 extracts new metadata from the event that is associated with the topic. In the continuing example, topic processor 215 may extract information such as the time of the data feed, geographical location (i.e. latitude and longitude) of the service provider, weather information in surrounding location, etc., of the WMD data feed.

At step 420, topic processor 215 updates the appropriate topic information with new event information extracted in step 418.

At step 422, publisher 240 monitors topic information 125a-125n and recognizes the new event information.

At step 424, publisher 240 updates discovery service 135 with information about the new event information about topic 125. In the continuing example, publisher 240 communicates new WMD intelligence feed topic information to discovery service 135, and a new entry is created under the listing “intelligence feed”, for example, in UDDI format of discovery service 135. Method 400 ends.

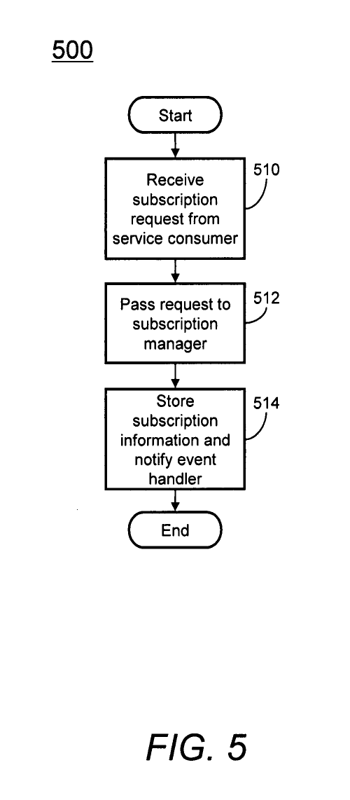

FIG. 5 illustrates a flow diagram of an exemplary method 500 of processing a subscription request to a topic from a service consumer 110 in accordance with the invention.

At step 510, a service consumer 110 that wishes to subscribe to a topic 125 identifies the location of metabroker 130 that is attached to the topic 125 of interest. At step 510, broker 105 receives a subscription request from a service consumer. For example, the service consumer 110 may use a client application to create a request command to subscribe to a topic with a keyword or keywords related to “WMD intelligence data.”

At step 512, the subscription request is passed to subscription manager 230.

At step 514, subscription manager 230 updates or creates a new entry with the new subscription request. The entry includes a location (e.g., URL address) to which distributions should be sent. Subscription manager further informs event handler 210 of the subscription so that event handler 210 can send appropriate communications to the subscribing service consumer 110 when new information is available about the topic of interest. Method 500 ends.

While this invention has been particularly described and illustrated with reference to exemplary embodiments thereof, it will be understood by those skilled in the art that changes in the above description or illustrations may be made with respect to form or detail without departing from the spirit or scope of the invention.

What is claimed is:

1. A computer-based method for dynamically discovering and communicating data in a communications network, comprising:
receiving, at a broker in a communications network, a communication from a first service provider over the communications network, the communication comprising data about a first topic, the broker comprising a metabroker and a service broker;
communicating messages from the metabroker to the service broker within defined time intervals to provide the service broker with any updated information about topics including the first topic;
sending information about the first topic to a first service consumer over the communications network within a first time interval from receipt of the communication comprising data about the first topic;
establishing peer-to-peer communication between the first service provider and the first service consumer over the communications network so that the first service provider and the first service consumer can communicate regarding the first topic;
receiving further communications about topics from multiple service providers over the communications network, at least one of the further communications including further data about the first topic; and
sending information about the further data to the first service consumer within a second time interval from receipt of the further data.

2. The method of claim 1, the metabroker communicating said messages to the service broker at regularly spaced time intervals.

3. The method of claim 1, further comprising:
receiving a request for information about a topic from the first service consumer over a communications network; and
identifying the first service provider as a source of information in response to the request by the first service consumer.

4. The method of claim 1, further comprising: updating information about the first topic based upon the further data.

5. The method of claim 1, further comprising:
communicating with another broker in the communications network to both transmit and receive information relating to the first topic; and
updating information about the first topic based upon the information received.

6. A system for dynamically discovering and communicating data at a broker in a communications network, comprising:
a processing system, the processing system comprising a metabroker and a service broker; and
memory coupled to the processing system;
wherein the processing system is configured to:
receive a communication from a first service provider over the communications network, the communication comprising data about a first topic;
communicate messages from the metabroker to the service broker within defined time intervals to provide the service broker with any updated information about topics including the first topic;
send information about the first topic to a first service consumer over the communications network within a first time interval from receipt of the communication comprising data about the first topic;
establish peer-to-peer communication between the first service provider and the first service consumer over the communications network so that the first service provider and the first service consumer can communicate regarding the first topic;
receive further communications about topics from multiple service providers over the communications network, at least one of the further communications including further data about the first topic; and
send information about the further data to the first service consumer within a second time interval from receipt of the further data.

7. The system of claim 6, wherein the processing system is configured to cause the metabroker to communicate said messages to the service broker at regularly spaced time intervals.

8. The system of claim 6, wherein the processing system is further configured to:
receive a request for information about a topic from the first service consumer over a communications network; and
identify the first service provider as a source of information in response to the request by the first service consumer.

9. The system of claim 6, wherein the processing system is further configured to update information about the first topic based upon the further data.

10. The system of claim 6, wherein the processing system is configured to:
communicate with another broker in the communications network to both transmit and receive information relating to the first topic; and
update information about the first topic based upon the information received.

11. A computer readable medium having embodied therein executable program code for causing a processing system to dynamically discover and communicate data in a communications network, the processing system serving as a broker in the communications network, the processing system comprising a service broker and a metabroker, wherein the executable program code is adapted to a cause the processing system to:
receive a communication from a first service provider over the communications network, the communication comprising data about a first topic;
communicate messages from the metabroker to the service broker within defined time intervals to provide the service broker with any updated information about topics including the first topic;
send information about the first topic to a first service consumer over the communications network within a first time interval from receipt of the communication comprising data about the first topic;
establish peer-to-peer communication between the first service provider and the first service consumer over the communications network so that the first service provider and the first service consumer can communicate regarding the first topic;
receive further communications about topics from multiple service providers over the communications network, at least one of the further communications including further data about the first topic; and
send information about the further data to the first service consumer within a second time interval from receipt of the further data.

12. The computer readable medium of claim 11, wherein the executable program code is further adapted to cause the metabroker to communicate said messages to the service broker at regularly spaced time intervals.

13. The computer readable medium of claim 11, wherein the executable program code is further adapted to cause the processing unit to:
receive a request for information about a topic from the first service consumer over a communications network; and
identify the first service provider as a source of information in response to the request by the first service consumer.

14. The computer readable medium of claim 11, wherein the executable program code is further adapted to cause the processing system to update information about the first topic based upon the further data.

15. The computer readable medium of claim 11, wherein the executable program code is further adapted to cause the processing system to:
communicate with another broker in the communications network to both transmit and receive information relating to the first topic; and
update information about the first topic based upon the information received.

16. A communications system for dynamically discovering and communicating data in a communications network, comprising:
a first broker that communicates information in a communications network; and
a second broker that communicates information in the communications network,
each of the first and second brokers comprising
a processing system comprising a metabroker and a service broker, and
memory coupled to the processing system,
the processing system of each of the brokers being configured to
receive a communication from a service provider over the communications network, the communication comprising data about a topic,
communicate messages from the metabroker to the service broker of a given broker within defined time intervals to provide the service broker with any updated information about topics including said topic,
send information about the topic to a service consumer over the communications network within a first time interval from receipt of the communication comprising data about said topic,
establish peer-to-peer communication between the service provider and the service consumer over the communications network so that the service provider and the service consumer can communicate regarding said topic,
receive further communications about topics from multiple service providers over the communications network, at least one of the further communications including further data about said topic, and
send information about the further data to the service consumer within a second time interval from receipt of the further data.

17. The system of claim 16, wherein the processing systems of the first and second brokers are further configured to cause the respective metabroker to communicate said messages to the respective service broker at regularly spaced time intervals.
